(19) United States
(12) Patent Application Publication
(10) Pub. No.: US 2010/0169203 A1
(43) Pub. Date: Jul. 1, 2010

(54) Selecting Variables For A Treatment Optimization Model

(76) Inventor: Dmitri Semenov, Lakewood, CO (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/352,603

(22) Filed: Jan. 12, 2009

Related U.S. Application Data
(63) Continuation-in-part of application No. 12/346,404, filed on Dec. 30, 2008, now abandoned.

(51) Int. Cl. G06Q 40/00

(52) U.S. Cl. 705/35

(57) ABSTRACT

A system and method for selecting variables for a treatment optimization model, to determine an optimal treatment from a number of treatments for a financial account, is presented. A number of variables are stored in a storage bin defined in a database, such that each variable has at least N samples. A measure of informativity (inf) is selected for each one of the number of variables. A measure of usefulness (Mu) is selected for each one of the number of variables. An equation (mInf=inf+Mu*coeff) is calculated for each variable in each bin, where the coeff defines a relative general importance of each one of the number of variables, to determine a set of best variables from the storage bins. The optimal treatment is selected based on the set of best variables.

### CROSS REFERENCE TO RELATED APPLICATIONS

This Patent Application is a Continuation-In-Part Of U.S. patent application Ser. No. 12/346,404, Entitled, “Selecting Variables For A Treatment Optimization Model” Filed on Dec. 30, 2008, (Attorney Docket No.: 35006-667F01US) the contents of which are hereby incorporated by reference.

### BACKGROUND

This disclosure relates generally to treatment of problematic financial accounts, such as credit accounts, loans, etc., and more particularly to optimizing the treatment of such problematic financial accounts.

In financial services organizations, treatment of a problematic financial account involves determining to which agency the account should be sent, and how to work the account (whether to call during prime time, or send letter, or call and send letter, etc.). Success in addressing a problematic account involves determining the optimal treatment for each individual account, given the many decisions as to agency or work options. Conventional treatment optimization involves building a separate model for each treatment. Each separate model uses variable selection that is appropriate only to that model. However this model-by-model variable selection typically ends up in having strongly predictive variables that are poor for predicting differences between treatments.

### SUMMARY

In general, this document discusses a system and method for a process and system that selects variables that are both predictive and sensitive to treatment differences. It may be used for any problem in which variables need to be selected to differentiate classes of observations, such as collection and recovery models.

In one aspect, a computer implemented method for selecting variables for a treatment optimization model, to determine an optimal treatment from a number of treatments for a financial account, is disclosed. The method includes storing each one of a plurality of variables in a storage bin defined in a database, such that each variable has at least N samples, and selecting a measure of informativity (inf) for each one of the plurality of variables, which defines how good each variable is for making predictions. The method further includes selecting a measure of usefulness (Mu) for each one of the plurality of variables, which defines how good each variable is for making predictions of differences in an outcome of each of the number of treatments. The method further includes storing the measure of informativity and the measure of usefulness in a memory associated with the storage bins, and calculating an equation (mInf=inf+Mu*coeff) for each variable in each bin, where the coeff defines a relative general importance of each one of the plurality of variables, to determine a set of best variables from the storage bins. The method further includes storing the set of best variables in a second memory associated with the storage bins, and selecting, from the second memory, the optimal treatment based on the set of best variables.

In another aspect, a computer program product is presented. The computer program product includes a computer usable medium having a computer readable program code embodied therein and adapted to implement, when executed by a computer processor, a method for selecting variables for a treatment optimization model to determine an optimal treatment from a number of treatments for a financial account. The computer readable program code includes instructions for the computer processor to receive data representing a number of variables associated with the financial account, and store each one of a plurality of variables in at least one storage bin defined in a database, such that each variable has at least N samples. The computer readable program code further includes instructions to determine a measure of informativity (inf) for each one of the plurality of variables, the measure of informativity defining how good each variable is for making predictions, and to determine a measure of usefulness (Mu) for each one of the plurality of variables, the measure of usefulness defining how good each variable is for making predictions of differences in an outcome of each of the number of treatments. The computer readable program code further includes instructions to select a set of best variables from each variable in each storage bin based on inf and Mu, and to generate the optimal treatment based on the set of best variables.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 is flowchart of a method to select variables for a treatment optimization model.

FIG. 2 is a block diagram of a computing system on which a method for selecting variables for a treatment optimization model may be executed.

Like reference symbols in the various drawings indicate like elements.

### DETAILED DESCRIPTION

This document describes a system and method for selecting variables for a treatment optimization model, for optimized treatment of financial accounts such as credit accounts, loan accounts, billing accounts and other financial transaction accounts that require such treatment. In exemplary implementations, optimized treatment of an account means selecting the best agency to which to send an account, as well as selecting the best action of how to work an account (i.e., whether to call during prime time, or send letter, or call and send letter, etc.), on an account-by-account basis. The system and method may be used for any problem in which variables need to be selected to differentiate classes of observations, such as collection and recovery models.

In accordance with a preferred exemplary implementation, a measure Mu is constructed using the likelihood-ratio statistic (denoted as G²) used for tests of independence of two-way contingency tables. First, consider the case of predicting a binary variable (i.e. an event), which takes the value of 0 or 1, and a predictor being the probability of the event. In accordance with preferred implementations, the following are assumed:

a. there are s treatments (agencies).

b. each variable ζ is binned into k bins

The measure Mu is constructed as a sum of measures over subsamples, where the subsamples correspond to the bins. Variables may include: agency, state of residence, number of credit cards, number of delinquencies in the past 12 months, bankruptcy records, etc.

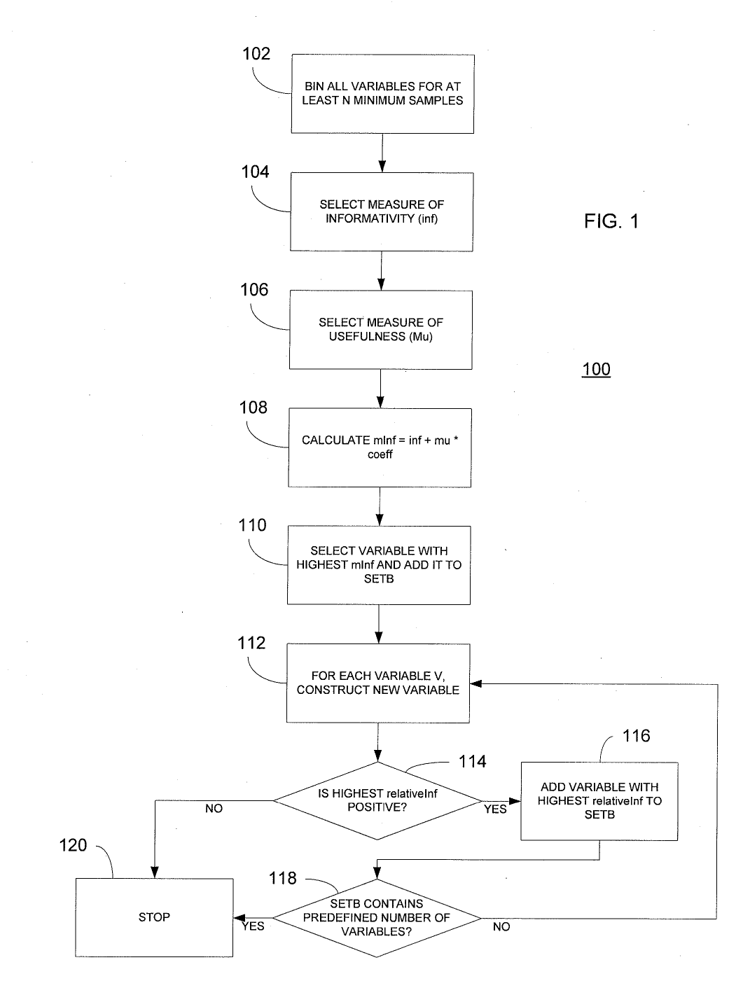

FIG. 1 is a flowchart of a method 100 for selecting variables for a treatment optimization model. At 102, all variables are stored in a bin so that each bin of each variable contains at least N_min samples. For example, a practical value for N_min is 20/event_rate. At 104, a measure of informativity (inf) is selected to measure how good each variable is for making predictions. One such measure is the information content of empirical distribution of outcomes over the bins of a variable minus the information content of encoding the binning using predefined coding schema. Other measures of inf can be used.

At 106, a measure of usefulness is selected to measure how good each variable is for making predictions of differences in outcomes between all treatments. Such measure of usefulness should be compatible with the informativity measure from the previously-described step. One such measure of usefulness is called Mu. At 108, mInf=inf+Mu*coeff is calculated, where coeff is a parameter that controls a relative importance of general predictiveness of a variable versus predictiveness of differences in treatments. Practical values for coeff are between −4 and 4. Negative values are used for select highly predictive variables that are robust to changes in treatment, while positive values are used to select variables that are sensitive to differences between treatments.

At 110, the variable with the highest mInf is selected and added to a set of the best variables (setB). The setB can be a particular memory location or designation in a memory or database. At 112, for each variable V not yet included into the setB, and each variable from the setB, a new variable is constructed that is a Cartesian product of the two. The inf measure for the Cartesian product is found, and then the relativeInf of V is calculated as the minimum inf of such Cartesian products of V with variables in the setB.

At 114, it is determined whether the highest relativeInf is positive. If yes, then the variable with the highest relativeInf is added to setB, at 116. Otherwise, if no, the process is stopped, at 120. At 118, it is determined whether setB contains the predefined number of variables. If yes, then the process is stopped, at 120. Otherwise, the process returns to step 112.

Let ψ denote a sample (=a set of events), and ψᵢ denotes the subset of ψ to which the treatment i is applied. Accordingly, it can be defined:

$$δ ( ψ ) ≡ Entropy ( ψ ) - {\sum }_{i} Entropy ( {ψ}_{i} ) , \\ where$$

$$Entropy ( ψ ) ≡ - N ( ψ ) \cdot ( p ( ψ ) \cdot log ( p ( ψ ) ) + q ( ψ ) \cdot log ( q ( ψ ) ) )$$

$$p ( ψ ) = \frac{( {\sum }_{event = 1} 1 )}{N ( ψ )}$$

$$q ( ψ ) = \frac{( {\sum }_{event = 0} 1 )}{N ( ψ )}$$

$$N ( ψ ) = {\sum }_{ψ} 1 ≡ \vert ψ \vert$$

Let Eδ(t₁, t₂, . . . tₛ)= [symbol] δ(ψ)∥ψ₁|=t₁,|ψ₂|=t₂, . . . |ψₛ|=tₛ [symbol] where average [symbol] is over all configurations having p(ψ)=p.

In other words, δ is G²/2 statistic, and Eδ(t₁,t₂, . . . tₛ) is an average δ over all configurations of events where a number of events and a number of samples in each treatment are fixed. Let ψ^{j} denote all samples that fall into bin j of the variable ζ. Then, a proposed measure of usefulness of ζ for predicting differences between treatments 1 . . .s is:

$$μ ( ψ , ζ ) = \frac{1}{N ( ψ )} \cdot {\sum }_{i = 1}^{k} ( δ ( {ψ}^{i} ) - E δ ( \vert {ψ}_{1}^{i} \vert , \vert {ψ}_{2}^{i} \vert , … \vert {ψ}_{s}^{i} \vert ) )$$

If there are no differences between distribution of events among treatments then δ(ψ)=0 for all bins, then μ(ψ,ζ)<0. Accordingly, the above method and algorithm, and variants thereof, can be used to select variables for a treatment optimization model.

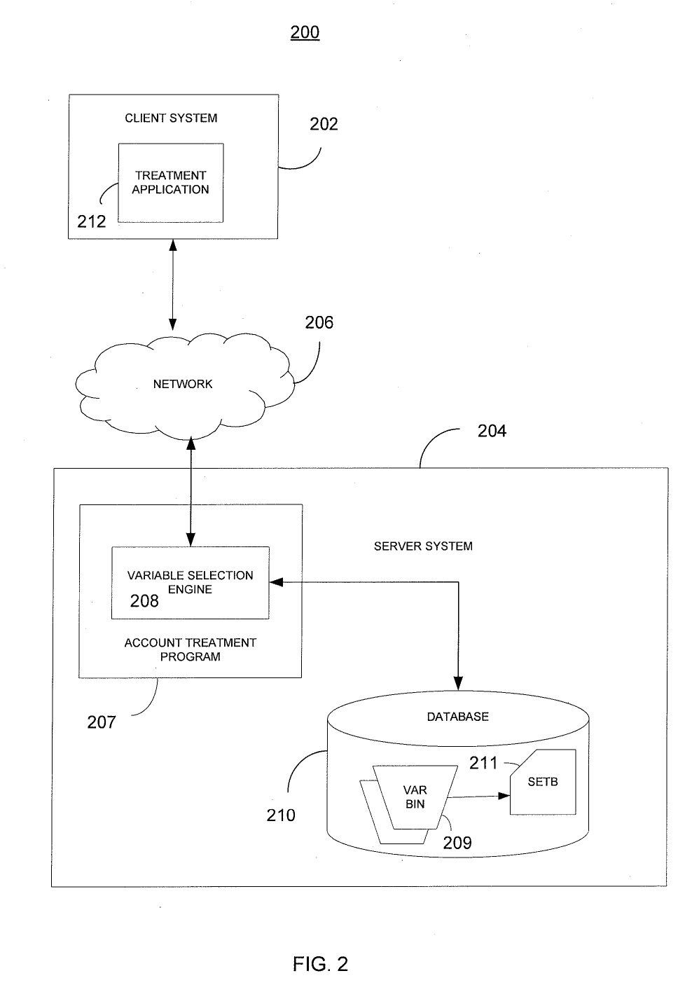

FIG. 2 illustrates a computing system 200 that is suitable for hosting and executing the above-described method and algorithms. The computing system 200 includes one or more client systems 202 (illustrated herein as one client system 202) connected with and communicating with one or more server systems 204 (illustrates herein as one server system 204 for simplicity) via a network 206. The network 206 can be a wireless or a wired network, or other type of communication network.

The server system 204 includes a variable selection engine 208 as a component of an account treatment program 207. The account treatment program 207 may be implemented in part as executable code that can be downloaded or delivered to the client system 202 via the network in a client/server model, or may be stored and executed locally on the client system 202. The account treatment program 207 and the variable selection engine 208 may include a processor or part of a processor that executes the executable code. The variable selection engine 208 executes a method as described above to select variables for treatment optimization, for treatments processed by the account treatment program 207.

The server system 204 further includes a database 210 or other memory arrangement or schema, for storing and arranging the bins 209, as well as the setB that contains the predefined number of selected variables. The data in the database 210 that represents the variables and/or setB may be accessed by the account treatment program 207 and variable selection engine 208 for use by a treatment application 212 run on the client system 202. For example, the treatment application 212 may allow a user to perform and manage a treatment that is optimized for each particular account, on an account-by-account basis, as determined by the variable selection engine in accordance with the methods and algorithms described above.

Some or all of the functional operations described in this specification can be implemented in digital electronic circuitry, or in computer software, firmware, or hardware, including the structures disclosed in this specification and their structural equivalents, or in combinations of them. Embodiments of the invention can be implemented as one or more computer program products, i.e., one or more modules of computer program instructions encoded on a computer readable medium, e.g., a machine readable storage device, a machine readable storage medium, a memory device, or a machine-readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, that is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments of the invention have been described. Other embodiments are within the scope of the following claims. For example, the steps recited in the claims can be performed in a different order and still achieve desirable results. In addition, embodiments of the invention are not limited to database architectures that are relational; for example, the invention can be implemented to provide indexing and archiving methods and systems for databases built on models other than the relational model, e.g., navigational databases or object oriented databases, and for databases having records with complex attribute structures, e.g., object oriented programming objects or markup language documents. The processes described may be implemented by applications specifically performing archiving and retrieval functions or embedded within other applications.

What is claimed:

1. A computer implemented method for selecting variables for a treatment optimization model to determine an optimal treatment from a number of treatments for a financial account, the method comprising:
storing each one of a plurality of variables in a storage bin defined in a database, such that each variable has at least N samples;
selecting a measure of informativity (inf) for each one of the plurality of variables, the measure of informativity defining how good each variable is for making predictions;
selecting a measure of usefulness (Mu) for each one of the plurality of variables, the measure of usefulness defining how good each variable is for making predictions of differences in an outcome of each of the number of treatments;
storing the measure of informativity and the measure of usefulness in a memory associated with the storage bins;
calculating an equation (mInf=inf+Mu*coeff) for each variable in each bin, where the coeff defines a relative general importance of each one of the plurality of variables, to determine a set of best variables from the storage bins;
storing the set of best variables in a second memory associated with the storage bins; and
selecting, from the second memory, the optimal treatment based on the set of best variables.

2. The computer implemented method of claim 1, wherein the treatment includes a designation for an agency and a designation for an action by the agency.

3. The computer implemented method of claim 2, wherein the plurality of variables include a plurality of agencies and a plurality of actions by each of the plurality of agencies.

4. The computer implemented method of claim 1, wherein the plurality of variables include a number of credit cards associated with the financial account, and a number of delinquencies in a predetermined period of time associated with each one of the credit cards.

5. The computer implemented method of claim 1, wherein the measure of informativity is represented as the information content of empirical distribution of outcomes over the bins of a variable processed by the computer, minus the information content of encoding the binning where the computer uses a predefined coding schema.

6. A computer implemented method for selecting variables for a treatment optimization model to determine an optimal treatment from a number of treatments for a financial account, the method comprising:
receiving data representing a plurality of variables associated with the financial account;
storing each one of a plurality of variables in at least one storage bin defined in a database, such that each variable has at least N samples;
determining a measure of informativity (inf) for each one of the plurality of variables, the measure of informativity defining how good each variable is for making predictions;
determining a measure of usefulness (Mu) for each one of the plurality of variables, the measure of usefulness defining how good each variable is for making predictions of differences in an outcome of each of the number of treatments;
determining a set of best variables from each variable in each storage bin based on inf and Mu;
generating the optimal treatment based on the set of best variables.

7. The computer implemented method of claim 6, wherein the treatment includes a designation for an agency and a designation for an action by the agency.

8. The computer implemented method of claim 7, wherein the plurality of variables include a plurality of agencies and a plurality of actions by each of the plurality of agencies.

9. The computer implemented method of claim 6, wherein the plurality of variables include a number of credit cards associated with the financial account, and a number of delinquencies in a predetermined period of time associated with each one of the credit cards.

10. The computer implemented method of claim 6, wherein the measure of informativity is represented as the information content of empirical distribution of outcomes over the bins of a variable processed by the computer, minus the information content of encoding the binning where the computer uses a predefined coding schema.

11. A computer program product, comprising a computer usable medium having a computer readable program code embodied therein, the computer readable program code adapted to implement, when executed by a computer processor, a method for selecting variables for a treatment optimization model to determine an optimal treatment from a number of treatments for a financial account, the computer readable program code comprising instructions for the computer processor to:
receive data representing a plurality of variables associated with the financial account;
store each one of a plurality of variables in at least one storage bin defined in a database, such that each variable has at least N samples;
determine a measure of informativity (inf) for each one of the plurality of variables, the measure of informativity defining how good each variable is for making predictions;
determine a measure of usefulness (Mu) for each one of the plurality of variables, the measure of usefulness defining how good each variable is for making predictions of differences in an outcome of each of the number of treatments;
select a set of best variables from each variable in each storage bin based on inf and Mu; and
generate the optimal treatment based on the set of best variables.

12. The computer program product of claim 11, wherein the instructions for the computer processor to select a set of best variables from each variable in each storage bin based on inf and Mu includes instructions to execute the equation: (mInf=inf+Mu*coeff) for each variable in each bin, where the coeff defines a relative general importance of each one of the plurality of variables.
